(19) United States
(12) Patent Application Publication
(10) Pub. No.: US 2014/0069683 A1
(43) Pub. Date: Mar. 13, 2014

(54) MULTI-CORE CABLE

(71) Applicant: SUMITOMO ELECTRIC INDUSTRIES, LTD., Osaka (JP)

(72) Inventors: Masato TANAKA, Kanuma-shi (JP); Kazuhiro SATO, Kanuma-shi (JP); Tatsunori HAYASHISHITA, Hachinohe-shi (JP)

(73) Assignee: SUMITOMO ELECTRIC INDUSTRIES, LTD., Osaka (JP)

(21) Appl. No.: 14/022,438

(22) Filed: Sep. 10, 2013

(30) Foreign Application Priority Data
Sep. 11, 2012 (JP) 2012-199218

(51) Int. Cl. H01B 7/00

(52) U.S. Cl. CPC H01B 7/0009
USPC 174/107; 174/113 R

(57) ABSTRACT

One embodiment is related to a multi-core cable. The multi-core cable includes: plural electric wire units in each of which plural coaxial electric wires or insulated electric wires are bundled; and a sheath collectively covering the electric wire units. The electric wire units are arranged so as to form plural layers around a center of the multi-core cable. And, each of the layers is stranded in the same direction at an equal pitch.

### CROSS-REFERENCE TO RELATED APPLICATION(S)

This application claims priority/priorities from Japanese Patent Application No. 2012-199218 filed on Sep. 11, 2012, the entire contents of which are incorporated herein by reference.

### FIELD

The present invention relates to a multi-core cable, and to a multi-core cable used in wiring of, for example, a Charge Coupled Device (CCD) camera, an endoscope or an ultrasonograph for medical use.

### BACKGROUND

There has been conventionally known a multi-core cable having multiple ultrathin insulated electric wires or coaxial cables (coaxial electric wires). For example, as shown in FIG. 3, each coaxial cable 40 includes a central conductor 41, an insulator 42 covering the central conductor 41, an outside shielding member (external conductor) 43 covering the insulator 42, and a sheath 44 covering the shielding member 43.

The multi-core cable is constructed by collecting the plural coaxial cables 40 and covering the outside of the coaxial cables 40 with a sheath member. This sheath member includes a wrapping, a shielding member and a sheath. The wrapping is formed in the inside. The shielding member is formed on the outside of the wrapping and has electromagnetic shielding characteristics. The sheath is provided as a tubular resin material formed on the outside of the shielding member.

For example, JP-2006-196289-A discloses a multi-core cable having high bendability, that is, high mechanical reliability on repeated bending stress. As shown in FIG. 4, this multi-core cable 50 includes a central part 60, a peripheral part 70 arranged on the periphery of the central part 60, a wrapping 81 wrapped around the outside of the peripheral part 70, a shielding layer 82 wrapped around the outside of the wrapping 81, and a sheath 90 formed on the outside of the shielding layer 82 as the outermost layer.

The central part 60 is constructed by arranging a bundle 51 of high-tensile fibers (tension members) in the center (center of the multi-core cable 50) P0 of the central part 60, arranging plural first coaxial cables 61 on the periphery of the bundle 51 into a layer, and winding a marker wrapping 62 on the outsides of the first coaxial cables 61. The marker wrapping 62 has a function of indicating a kind etc. of first coaxial cables. Also, the marker wrapping 62 is wrapped in a direction opposite to a strand direction of the first coaxial cables 61 and is wound to thereby prevent disarray of the first coaxial cables 61.

The peripheral part 70 is formed by arranging plural electric wire units 71 around the central part 60. Plural second coaxial cables (not shown) are included in each of the electric wire units 71.

In the central part 60, the plural first coaxial cables 61 are arranged into plural layers so as to be concentric with respect to the center P0, and are stranded every layer. Also in the peripheral part 70, the plural electric wire units 71 are arranged so as to be concentric with respect to the center P0.

In JP-2006-196289-A, when the number of electric wire units is large, their electric wire units are divided into plural layers (for example, a central layer, a second layer and a third layer), and a collective pitch (strand pitch) of each layer is differentiated. For example, the collective pitches of the central layer, the second layer and the third layer are respectively set at 37.5 mm, 50 mm and 100 mm. The “collective pitch (strand pitch)” corresponds to a distance in a length direction of the multi-core cable through which the electric wire unit rotates 360 degrees. In JP-2006-196289-A, unevenness in appearance is reduced by differentiating the collective pitches of the layers

As shown in JP-2006-196289-A, when the collective pitch every layer differs, arrangement of the electric wire units varies depending on a cut position of the multi-core cable. As a result, in a wire alignment step of connecting each electric wire to a substrate, the mutual electric wires are respectively arranged so as to be crossed. Then, when the electric wires are crossed, wire alignment workability becomes worse. Also, when movement such as bending is applied at the time of use of a product, the electric wire in the crossing place may be strained to cause a break in the wire.

### SUMMARY

One object of the invention is to equalize arrangement of electric wire units regardless of a cut position of a multi-core cable in the multi-core cable including plural electric wire units obtained by bundling plural coaxial electric wires or insulated electric wires and collectively covering the electric wire units with a sheath.

One aspect of the present invention provides a multi-core cable including:

plural electric wire units in each of which plural coaxial electric wires or insulated electric wires are bundled; and

a sheath collectively covering the electric wire units,

wherein the electric wire units are arranged so as to form plural layers around a center of the multi-core cable, and each of the layers is stranded in the same direction at an equal pitch.

There may also be provide the multi-core cable,

wherein the plural electric wire units are collectively covered with a shielding layer, and the shielding layer is further covered with the sheath.

There may also be provide the multi-core cable,

wherein a gap is formed between the sheath and an inside layer nearest to the sheath.

There may also be provide the multi-core cable,

wherein the plural electric wire units include plural kinds of electric wire units.

There may also be provide the multi-core cable,

wherein the number of electric wire units of each kind is an even number.

There may also be provide the multi-core cable,

wherein electric wire units of each kind are point symmetrically arranged when viewed from a length direction of the multi-core cable.

In a harness product, the distal end of a cable is generally exposed slightly, and attachment work with respect to a substrate is done. Since it is difficult to perform the attachment work when the exposed place is short, it is necessary to select a proper work method according to an electric wire structure. For example, when the number of substrates for connecting a probe is an even number, for example, two, four or six and the number of electric wire units in a multi-core electric wire is also an even number, good workability can be obtained by doing attachment work so as to divide the electric wire units into two groups.

According to the invention, in the multi-core cable including plural electric wire units obtained by bundling plural coaxial electric wires or insulated electric wires and collectively covering the electric wire units with a sheath, the electric wire units are arranged so as to form plural layers around the center of the multi-core cable and also each of the layers is stranded in the same direction at an equal pitch. Therefore, arrangement of the electric wire units can be equalized regardless of a cut position of the multi-core cable.

### BRIEF DESCRIPTION OF DRAWINGS

FIG. 1 is a sectional view showing a multi-core cable according to one embodiment.

FIG. 2 is a sectional view showing a multi-core cable according to another embodiment.

FIG. 3 is a perspective view showing one example of a coaxial cable provided inside a multi-core cable.

FIG. 4 is a sectional view showing one example of a conventional multi-core cable.

### DETAILED DESCRIPTION

A multi-core cable of the embodiment will hereinafter be described with reference to the drawings.

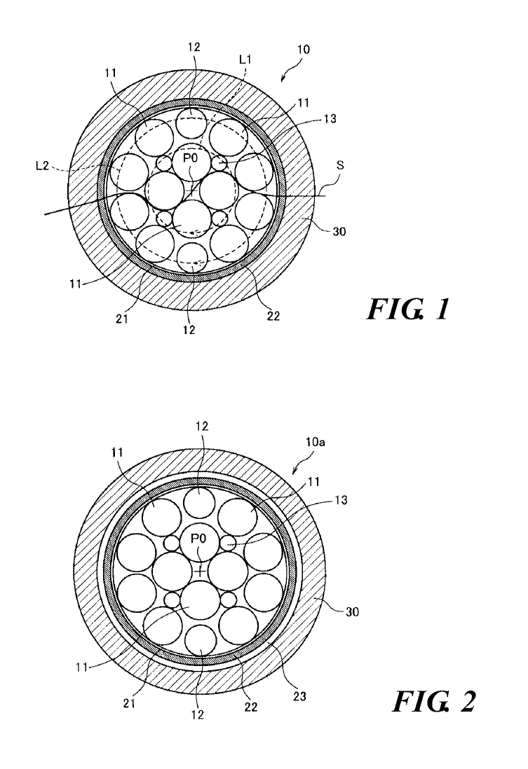

As shown in FIG. 1, a multi-core cable 10 of the embodiment includes plural electric wire units 11, 12, 13 and a sheath 30 collectively covering the electric wire units 11, 12, 13. The electric wire units 11, 12, 13 have a large diameter, a middle diameter and a small diameter, respectively.

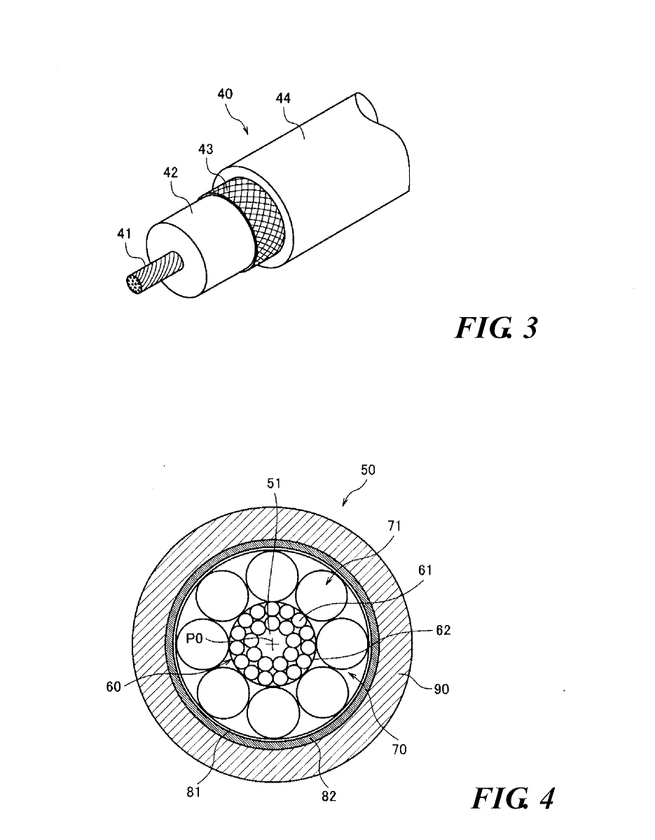

While plural coaxial cables (coaxial electric wires as shown in FIG. 3) or insulated electric wires are bundled in any kinds of electric wire units 11, 12, 13, arrangement and/or the number of electric wires differ among the kinds of electric wire units 11, 12, 13. In each of the electric wire units, the coaxial electric wires or the insulated electric wires may be arranged into one layer having a circular section, or into plural layers having a section of concentric circles.

FIG. 1 shows an example in which four small-diameter electric wire units 13, two middle-diameter electric wire units 12 and twelve large-diameter electric wire units 11 are formed as the plural electric wire units arranged inside the multi-core cable 10. Although a kind of electric wire unit or the number of electric wire units of each kind is not limited thereto, the number of electric wire units of each kind is preferably an even number as described below.

The electric wire units 11, 12, 13 are arranged so as to form plural layers around the center P0 of the multi-core cable 10. In the multi-core cable 10, the electric wire units 11, 12, 13 are arranged into plural layers which are concentric with respect to the center P0, and the sheath 30 functions as the outermost layer.

In this example, the electric wire units 11, 12, 13 are arranged so as to form a total of two layers of an internal layer L1 and an external layer L2. In the internal layer L1, the four electric wire units 11 are arranged, and the four electric wire units 13 are respectively arranged between the electric wire units 11. The external layer L2 is arranged on the periphery of the internal layer L1. In the external layer L2, the eight electric wire units 11 are arranged, and the two electric wire units 12 are arranged so as to partition the electric wire units 11 every four units. The electric wire units of each of the layers L1 and L2 are respectively arranged concentrically with respect to the center P0, and are stranded every layer. In addition, a wrapping may be formed on the periphery of the internal layer L1.

The number of electric wire units of each kind in the multi-core cable is determined according to the number of substrates attached. Since connection to the even-numbered substrates is often made generally, the number of electric wire units of each kind is also preferably an even number.

As can be seen from one symmetric line S shown in FIG. 1, the electric wire units 11, 12, 13 have only to be arranged point symmetrically with respect to the center P0 of the multi-core cable 10.

In the multi-core cable 10, an electric wire cable group of the internal layer L1 and an electric wire cable group of the external layer L2 are arranged, but the number of layers may be three or more and also, arrangement of an electric wire cable in each layer is not limited to this arrangement, as long as the electric wire cables are arranged concentrically and point symmetrically with respect to the center P0. In addition, various combinations of diameters of the internal layer L1 and the external layer L2 can be considered. The diameter of each layer can be determined freely.

According to the embodiment, the electric wire units 11, 12, 13 are arranged such that each of the layers is stranded in the same direction at an equal pitch. The pitch refers to a strand pitch (a pitch in a longitudinal direction of the electric wire unit) for stranding and collecting the layer, and is also called a collective pitch. When the collective pitch differs or when a strand direction is opposite even for the same collective pitch, a positional relationship between the electric wire unit group of the internal layer L1 and the electric wire unit group of the external layer L2 deviates depending on a cut place. Hence, in the multi-core cable 10 of the embodiment, each of the layers is stranded in the same direction at the equal pitch. Consequently, the positional relationship between the respective electric wire units becomes equal in other cross sections as well as a cross section shown in FIG. 1.

By stranding each of the layers in the same direction at the equal pitch, even when the multi-core cable 10 is cut in any position, the electric wires can be arranged so as not to be mutually crossed in a wire alignment step of soldering to a substrate. As a result, wire alignment workability improves. Further, even when a strain relief part between the multi-core cable and the substrate is bent, the electric wire is not strained in the strain relief part. Therefore, mechanical reliability can be improved.

In the multi-core cable 10, preferably, the plural electric wire units 11, 12, 13 are collectively covered with a shielding layer 22, and the shielding layer 22 is further covered with the sheath 30, as shown in FIG. 1. The shielding layer 22 includes a metal wire braid, a metal wire lateral wrapping, a metal resin tape wrapping, etc. In the present embodiment, the plural electric wire units 11, 12, 13 are first collectively covered with a wrapping 21, and the wrapping 21 is further covered with the shielding layer 22. However, the wrapping 21 is omittable.

In the center P0 of the multi-core cable 10, that is, inside the electric wire units 11, 12, 13, a bundle of high-tensile fibers (tension members) may be arranged. Also, around the electric wire units 11, 12, 13, fibers may be interposed so as to fill gaps between the electric wire units 11, 12, 13.

FIG. 2 is a sectional view showing a multi-core cable according to the another embodiment.

As shown in FIG. 2, in a multi-core cable 10a according to the another embodiment, a gap (air gap layer) 23 is formed between a sheath 30 and an inside layer of the sheath 30. The gap 23 can be formed by properly adjusting a metal mold, a wire speed, etc. during extrusion molding of the sheath 30.

When both of a wrapping 21 and a shielding layer 22 are provided, the shielding layer 22 is the “inside layer of the sheath 30”. When only the wrapping 21 is provided and the shielding layer 22 is omitted, the wrapping 21 is the “inside layer of the sheath 30”. And, when both of the shielding layer 22 and the wrapping 21 are not provided, an external layer L2 is the “inside layer of the sheath 30. Since the other configuration in the multi-core cable 10a is similar to that of the multi-core cable 10 of FIG. 1, the detailed description is omitted.

When each of the layers is stranded in the same direction at the equal pitch, unevenness in appearance may occur. However, by forming the gap 23 between the sheath 30 and the inside layer of the sheath 30 in this manner, even if unevenness in appearance occurs, the gap 23 can make it difficult to see its unevenness from the outside of the sheath 30. Specifically, by setting the gap 23 at 0.2 mm or more, the gap 23 can make it difficult to see the unevenness in appearance of the multi-core cable 10a. Also, flexibility of the cable improves by forming the gap 23.

1. A multi-core cable comprising:
plural electric wire units in each of which plural coaxial electric wires or insulated electric wires are bundled; and
a sheath collectively covering the electric wire units,
wherein the electric wire units are arranged so as to form plural layers around a center of the multi-core cable, and each of the layers is stranded in the same direction at an equal pitch.

2. The multi-core cable of claim 1,
wherein the plural electric wire units are collectively covered with a shielding layer, and the shielding layer is further covered with the sheath.

3. The multi-core cable of claim 1,
wherein a gap is formed between the sheath and an inside layer nearest to the sheath.

4. The multi-core cable of claim 1,
wherein the plural electric wire units include plural kinds of electric wire units.

5. The multi-core cable of claim 4,
wherein the number of electric wire units of each kind is an even number.

6. The multi-core cable of claim 4,
wherein electric wire units of each kind are point symmetrically arranged when viewed from a length direction of the multi-core cable.
